(19) United States
(12) Patent Application Publication
(10) Pub. No.: US 2021/0257817 A1
(43) Pub. Date: Aug. 19, 2021

(54) TOP HAT FOR ELECTRICAL PANEL

(71) Applicant: Faith Technologies, Inc., Menasha, WI (US)

(72) Inventor: Jody David Seubert, Appleton, WI (US)

(21) Appl. No.: 17/161,793

(22) Filed: Jan. 29, 2021

Related U.S. Application Data
(60) Provisional application No. 62/968,703, filed on Jan. 31, 2020.

(51) Int. Cl. H02B 1/06; H02B 1/30

(52) U.S. Cl. CPC H02B 1/06; H02B 1/305

(57) ABSTRACT

A top hat enclosure for use with an electrical panel, the electrical panel including at least one breaker and at least one panel pass-through aperture, includes a housing having at least one worker-accessible opening, a cover configured to cover the opening, and at least one enclosure pass-through aperture, wherein the enclosure pass-through aperture is configured to align with the panel pass-through aperture, and wherein the housing is configured to be disposed adjacent the electrical panel; and at least one finger-safe and/or tool-safe terminal configured to be wired to a breaker in the electrical panel through the enclosure pass-through aperture and the panel pass-through aperture.

The present application claims priority to the earlier-filed U.S. Provisional Patent Application Ser. No. 62/968,703, and hereby incorporates the subject matter of the provisional application in its entirety.

### BACKGROUND

Work in electrical panels can be dangerous, particularly when the electrical panel is energized or hot. Such work requires specialized personal protective equipment (PPE) to limit the effects of a potential arc flash or contact with live conductors. Because of the inherent safety risks, such work is slowed by the requirements to don appropriate PPE. This is a concern throughout construction and operation due to the nature of graduating adding circuits to the electrical panel as work proceeds.

To improve safety and to move such work into a different PPE category, the ability to separate junctions from energized buses would allow workers to add or remove circuits with reduced risk.

### SUMMARY

The present disclosure helps to diminish risk by providing finger-safe and/or tool-safe connections in an enclosure separate from but connected to an electrical panel. Once in place, the top hat enclosure provides access to circuit connections without exposure to electrical panel feeds or live bus bars. Rather than opening an energized electrical panel to connect an additional circuit, the worker can open the top hat enclosure and connect the circuit with less risk and a safer arc flash classification.

In one aspect, the present disclosure provides a top hat enclosure for use with an electrical panel, the electrical panel including at least one breaker and at least one panel pass-through aperture, the top hat enclosure including a housing having at least one worker-accessible opening, a cover configured to cover the opening, and at least one enclosure pass-through aperture, wherein the enclosure pass-through aperture is configured to align with the panel pass-through aperture, and wherein the housing is configured to be disposed adjacent the electrical panel; and at least one finger-safe and/or tool-safe terminal configured to be wired to a breaker in the electrical panel through the enclosure pass-through aperture and the panel pass-through aperture.

In another aspect, the present disclosure provides a method for improving the safety of an electrical installation, the method including providing a top hat enclosure for use with an electrical panel, the electrical panel including at least one breaker and at least one panel pass-through aperture, the top hat enclosure comprising a housing having at least one worker-accessible opening, a cover configured to cover the opening, and at least one enclosure pass-through aperture, wherein the enclosure pass-through aperture is configured to align with the panel pass-through aperture, and wherein the housing is configured to be disposed adjacent the electrical panel, and at least one finger-safe and/or tool-safe terminal; and wiring the finger-safe and/or tool-safe terminal to a breaker in the electrical panel through the enclosure pass-through aperture and the panel pass-through aperture such that a worker can access a circuit in the electrical panel via the finger-safe and/or tool-safe terminal in the top hat enclosure without opening the electrical panel.

An alternate aspect of the present disclosure provides an electrical panel system including an electrical panel including at least one breaker and at least one panel pass-through aperture; and a top hat enclosure disposed adjacent the electrical panel, the top hat enclosure including a housing having at least one worker-accessible opening, a cover configured to cover the opening, and at least one enclosure pass-through aperture, wherein the enclosure pass-through aperture is aligned with the panel pass-through aperture, and at least one finger-safe and/or tool-safe terminal configured to be wired to a breaker in the electrical panel through the enclosure pass-through aperture and the panel pass-through aperture, wherein the enclosure pass-through aperture abuts the panel pass-through aperture, and wherein the enclosure pass-through aperture and the panel pass-through aperture are sealed with a cable entry plate.

Still another aspect of the present disclosure provides an electrical panel system including an electrical panel including a plurality of breakers and at least one panel pass-through aperture; and a top hat enclosure disposed adjacent the electrical panel, the top hat enclosure including a housing having at least one worker-accessible opening, a cover configured to cover the opening, and at least one enclosure pass-through aperture, wherein the enclosure pass-through aperture is aligned with the panel pass-through aperture, a plurality of finger-safe and/or tool-safe terminals each configured to be wired to a unique breaker in the electrical panel through the enclosure pass-through aperture and the panel pass-through aperture, wherein each finger-safe and/or tool-safe terminal is configured to receive a conductor from an installed building circuit, wherein the enclosure pass-through aperture abuts the panel pass-through aperture, and wherein the enclosure pass-through aperture and the panel pass-through aperture are sealed with a cable entry plate, and a covered gutter within the top hat enclosure to accommodate a feeder passing through the top hat enclosure to the electrical panel.

### BRIEF DESCRIPTION OF THE DRAWINGS

The foregoing and other features and aspects of the present disclosure and the manner of attaining them will become more apparent, and the disclosure itself will be better understood by reference to the following description, appended claims and accompanying drawings, where:

FIG. 1 representatively and photographically illustrates an elevation view of the electrical panel system of the present disclosure; and

FIG. 2 representatively and photographically illustrates an elevation view of the top hat portion of the electrical panel system of FIG. 1.

Repeat use of reference characters in the present specification and drawings is intended to represent the same or analogous features or elements of the present disclosure. The drawings are representational and are not necessarily drawn to scale. Certain proportions thereof might be exaggerated, while others might be minimized.

### DETAILED DESCRIPTION

Reference now will be made in detail to various aspects of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one aspect, can be used on another aspect to yield a still further aspect. Thus, it is intended that the present disclosure covers such modifications and variations as come within the scope of the appended claims and their equivalents.

Generally speaking, the present disclosure is directed to a top hat enclosure associated with an electrical panel such that an electrical circuit can be added to the electrical panel without opening the panel cover and thereby being exposed to the electrical panel's live bus bars or energized components. The top hat enclosure includes finger-safe and/or tool-safe terminations to allow connections without exposure to a live bus. The top hat enclosure is separate from but connected to an electrical panel. Once in place, the top hat provides access to circuit connections without exposure to feeds or live bus bars. Rather than connecting an additional circuit in the live electrical panel, the worker can open the top hat enclosure and connect the circuit with less risk and a safer arc flash classification.

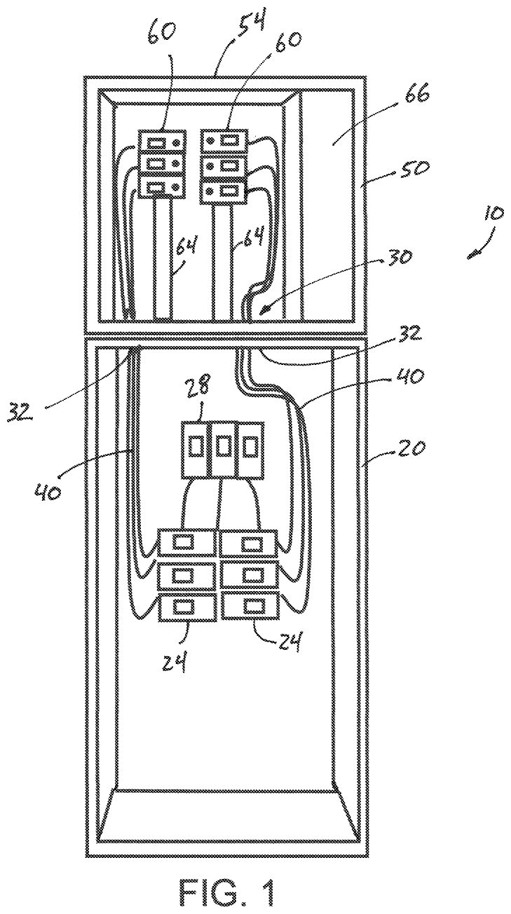

FIG. 1 illustrates the electrical panel system 10 of the present disclosure. The electrical panel system 10 includes an electrical panel 20 and a top hat enclosure 50. The electrical panel 20 includes one or more breakers 24 each configured to provide electricity to an installed building circuit. The electrical panel 20 also generally includes one or more main breakers 28 and an incoming panel feeder line (not shown) that brings electricity to the electrical panel 20. The electrical panel 20 will also include a cover with an access panel (not shown) to limit exposure to the inside of the electrical panel 20 when energized.

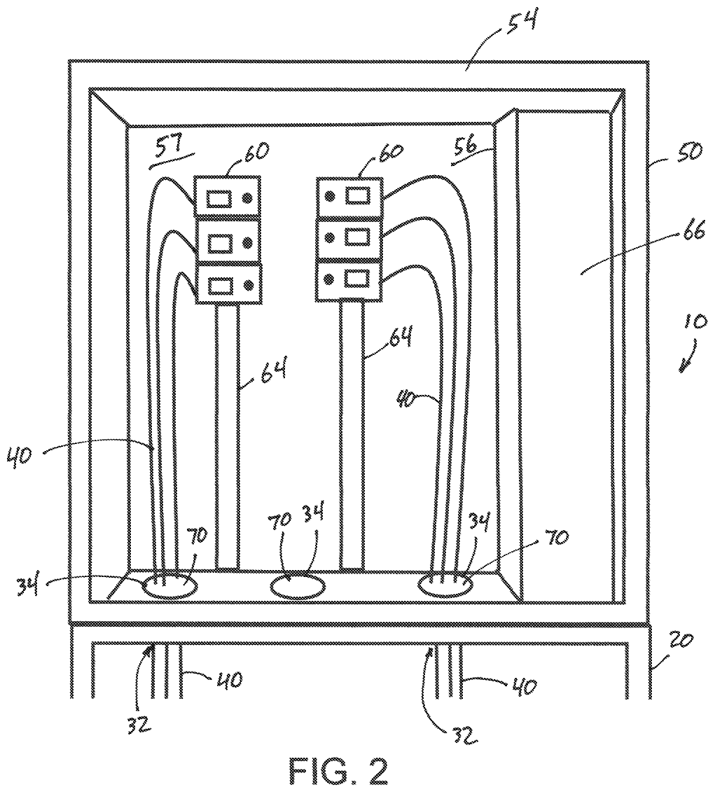

The electrical panel 20 also includes one or more apertures 30 through which wires 40 are run to and from the breakers 24. As illustrated in FIGS. 1 and 2, one or more of these apertures 30 are panel pass-through apertures 32 that are described in more detail below.

The electrical panel system 10 of the present disclosure also includes a top hat enclosure 50. The top hat enclosure 50 is typically disposed adjacent the electrical panel 20 but can, in other aspects, be disposed in a manner spaced apart from the electrical panel 20. The top hat enclosure 50 includes a housing 54 having at least one worker-accessible opening 58 and a cover (not shown) configured to cover the opening 58 to limit exposure to the inside of the top hat enclosure 50. The housing 54 is preferably constructed from the same material used to construct the electrical panel 20, such as coated steel, although any suitable material can be used.

The top hat enclosure 50 also includes one or more apertures 30 through which wires 40 are run to and from the housing 54. As illustrated in FIGS. 1 and 2, one or more of these apertures 30 are enclosure pass-through apertures 34. In a typical installation, the top hat enclosure 50 is disposed adjacent the electrical panel 20 such that the one or more enclosure pass-through apertures 34 align with the one or more panel pass-through apertures 32. This arrangement allows wiring to pass between the electrical panel 20 and the top hat enclosure 50 without exposure to the surrounding environment.

The top hat enclosure 50 also includes one or more finger-safe and/or tool-safe terminals 60 each mounted on a DIN rail 64 in the top hat enclosure 50. DIN rails 64 in the top hat enclosure 50 are used for mounting only and are not energized. In one aspect, each finger-safe and/or tool-safe terminal 60 is wired to the output of a unique breaker 24 in the electrical panel 20 via the enclosure pass-through aperture 34 and the panel pass-through aperture 32. In this manner, a worker can access the output of a circuit breaker 24 without accessing the breaker 24 itself by working with the finger-safe and/or tool-safe terminal 60 electrically connected to the output of that breaker 24. Each finger-safe and/or tool-safe terminal 60 is configured to receive a conductor from an installed building circuit. The finger-safe and/or tool-safe terminals 60 can be of identical amperage or other ratings or can include a mix of two or more amperage or other ratings. In the illustrated aspect, the finger-safe and/or tool-safe terminals 60 are PT-4 (32 amp), PT-10 (57 amp), PT-16 (76 amp), and PT-35 (125 amp) terminals available from Phoenix Contact, although any suitable finger-safe and/or tool-safe terminals 60 can be used.

The top hat enclosure 50 can also include a covered gutter 66 within the top hat enclosure 50 to accommodate a panel feeder or electricity supply conductor passing through the top hat enclosure 50 to the main breakers 28 in the electrical panel 20. The housing 54 of the top hat enclosure 50 includes right and left interior regions 56, 57. In one aspect, the covered gutter 66 is interchangeable between the right and left interior regions 56, 57.

The electrical panel system 10 can also include a gasket or grommet 70 (see FIG. 2) in the form of a cable entry plate seated at each point where an enclosure pass-through aperture 34 meets a panel pass-through aperture 32. In the illustrated aspect the cable entry plate is an ICOTEK KEL-DPZ 63135 cable entry plate available from icotek Corp., although any suitable sealing system can be used. The cable entry plate creates a barrier between the environments of the electrical panel 20 and the top hat enclosure 50 and is constructed such that wires 40 can be pushed through the cable entry plate on their run between the electrical panel 20 and the top hat enclosure 50 without compromising the seal between the electrical panel 20 and the top hat enclosure 50.

In other aspects of the present disclosure, the top hat enclosure 50 can be disposed in a spaced-apart manner from the electrical panel 20. In these aspects, the enclosure pass-through aperture 34 and the panel pass-through aperture 32 are also spaced apart and need to be connected using conduit or other protective structures including the appropriate fittings (not shown).

The electrical panel system 10 can be constructed on the intended site of its installation. The electrical panel system 10 can also be constructed off-site prior to shipment and installation at its intended site. Prior to being energized the electrical panel system 10 can be constructed with minimal PPE requirements.

In use, the constructed electrical panel system 10 is installed in its intended position. Power is brought to the electrical panel system 10 by running a feeder through the covered gutter 66 in the top hat enclosure 50 and into the electrical panel 20 where it is terminated at the main breakers 28. Energizing the feeder will thereby energize the main breakers 28 and the circuit breakers 24 once the breakers 24 are closed. Such energization can occur with the electrical panel 20 closed and potentially locked to limit access to the main and circuit breakers 28, 24. Workers are required to use a high level of PPE when working in an energized electrical panel, so it is desired to limit or eliminate the need for such work.

When installed building circuits need to be energized, a worker can access the top hat enclosure 50 while leaving the electrical panel 20 closed. Working in the top hat enclosure 50 requires a reduced level of PPE because there are no exposed energized connections or buses in the top hat enclosure 50. The worker can bring conductors from installed building circuits into the top hat enclosure 50 and then connect each conductor to its appropriate finger-safe and/or tool-safe terminal 60. Because the finger-safe and/or tool-safe terminal 60 is already wired to the appropriate breaker 24, the installed building circuit can be energized without accessing the electrical panel 20. Additional installed building circuits can be connected via the top hat enclosure 50 at that or any future time also without accessing the electrical panel 20. Appropriate labeling on each breaker 24, wire 40, and/or finger-safe and/or tool-safe terminal 60 ensures that each installed building circuit is properly connected consistent with installation drawings. The cover of the top hat enclosure 50 can be closed when access to the top hat enclosure 50 is not needed.

While the disclosure has been described in detail with respect to specific aspects thereof, it will be appreciated that those skilled in the art, upon attaining understanding of the foregoing will readily appreciate alterations to, variations of, and equivalents to these aspects. Accordingly, the scope of the present disclosure should be assessed as that of the appended claims and any equivalents thereto. Additionally, all combinations and/or sub-combinations of the disclosed aspects, ranges, examples, and alternatives are also contemplated.

What is claimed:

1. A top hat enclosure for use with an electrical panel, the electrical panel including at least one breaker and at least one panel pass-through aperture, the top hat enclosure comprising:
a housing having at least one worker-accessible opening, a cover configured to cover the opening, and at least one enclosure pass-through aperture, wherein the enclosure pass-through aperture is configured to align with the panel pass-through aperture, and wherein the housing is configured to be disposed adjacent the electrical panel; and
at least one finger-safe and/or tool-safe terminal configured to be wired to a breaker in the electrical panel through the enclosure pass-through aperture and the panel pass-through aperture.

2. The top hat enclosure of claim 1, further comprising a covered gutter within the top hat enclosure to accommodate a feeder passing through the top hat enclosure to the electrical panel.

3. The top hat enclosure of claim 2, wherein the housing includes right and left interior regions, and wherein the covered gutter is interchangeable between the right and left interior regions.

4. The top hat enclosure of claim 1, wherein the enclosure pass-through aperture is connected to the panel pass-through aperture with a conduit.

5. The top hat enclosure of claim 1, wherein the enclosure pass-through aperture abuts the panel pass-through aperture, and wherein the enclosure pass-through aperture and the panel pass-through aperture are sealed with a cable entry plate.

6. The top hat enclosure of claim 1, wherein the electrical panel includes a plurality of breakers, the housing further comprising a plurality of finger-safe and/or tool-safe terminals, wherein each finger-safe and/or tool-safe terminal is configured to be wired to a unique breaker in the electrical panel through the enclosure pass-through aperture and the panel pass-through aperture.

7. The top hat enclosure of claim 6, wherein the plurality of finger-safe and/or tool-safe terminals includes terminals with different ratings.

8. The top hat enclosure of claim 1, wherein the finger-safe and/or tool-safe terminal is configured to receive a conductor from an installed building circuit.

9. The top hat enclosure of claim 1, wherein the finger-safe and/or tool-safe terminal is configured without a bus bar.

10. A method for improving the safety of an electrical installation, the method comprising:
providing a top hat enclosure for use with an electrical panel, the electrical panel including at least one breaker and at least one panel pass-through aperture, the top hat enclosure comprising a housing having at least one worker-accessible opening, a cover configured to cover the opening, and at least one enclosure pass-through aperture, wherein the enclosure pass-through aperture is configured to align with the panel pass-through aperture, and wherein the housing is configured to be disposed adjacent the electrical panel, and at least one finger-safe and/or tool-safe terminal; and
wiring the finger-safe and/or tool-safe terminal to a breaker in the electrical panel through the enclosure pass-through aperture and the panel pass-through aperture such that a worker can access a circuit in the electrical panel via the finger-safe and/or tool-safe terminal in the top hat enclosure without opening the electrical panel.

11. The method of claim 10, wherein the electrical panel includes a plurality of breakers, the housing further comprises a plurality of finger-safe and/or tool-safe terminals, and wherein each finger-safe and/or tool-safe terminal is wired to a unique breaker in the electrical panel through the enclosure pass-through aperture and the panel pass-through aperture.

12. The method of claim 11, wherein the plurality of finger-safe and/or tool-safe terminals includes terminals with different ratings.

13. The method of claim 10, wherein the finger-safe and/or tool-safe terminal is configured to receive a conductor from an installed building circuit.

14. The method of claim 10, wherein the finger-safe and/or tool-safe terminal is configured without a bus bar.

15. An electrical panel system comprising:
an electrical panel including at least one breaker and at least one panel pass-through aperture; and
a top hat enclosure disposed adjacent the electrical panel, the top hat enclosure including
a housing having at least one worker-accessible opening, a cover configured to cover the opening, and at least one enclosure pass-through aperture, wherein the enclosure pass-through aperture is aligned with the panel pass-through aperture, and
at least one finger-safe and/or tool-safe terminal configured to be wired to a breaker in the electrical panel through the enclosure pass-through aperture and the panel pass-through aperture, wherein the enclosure pass-through aperture abuts the panel pass-through aperture, and wherein the enclosure pass-through aperture and the panel pass-through aperture are sealed with a cable entry plate.

16. The system of claim 15, further comprising a covered gutter within the top hat enclosure to accommodate a feeder passing through the top hat enclosure to the electrical panel.

17. The system of claim 16, wherein the housing includes right and left interior regions, and wherein the covered gutter is interchangeable between the right and left interior regions.

18. The system of claim 15, wherein the electrical panel includes a plurality of breakers, the housing further comprising a plurality of finger-safe and/or tool-safe terminals, wherein each finger-safe and/or tool-safe terminal is configured to be wired to a unique breaker in the electrical panel through the enclosure pass-through aperture and the panel pass-through aperture.

19. The system of claim 18, wherein the plurality of finger-safe and/or tool-safe terminals includes terminals with different ratings.

20. The system of claim 15, wherein the finger-safe and/or tool-safe terminal is configured to receive a conductor from an installed building circuit.
